(19) United States
(12) Patent Application Publication
(10) Pub. No.: US 2025/0253575 A1
(43) Pub. Date: Aug. 7, 2025

(54) TAMPER RESISTANT SHUTTER AND RECEPTACLE INCLUDING THE SAME

(71) Applicant: EATON INTELLIGENT POWER LIMITED, DUBLIN 4 (IE)

(72) Inventors: CHUANCHUAN ZHUANG, Shanghai (CN); ERIK J. GOUHL, Fayetteville, GA (US); FENGGUO ZHANG, Shanghai (CN)

(73) Assignee: EATON INTELLIGENT POWER LIMITED, DUBLIN 4 (IE)

(21) Appl. No.: 19/045,193

(22) Filed: Feb. 4, 2025

Related U.S. Application Data
(60) Provisional application No. 63/550,143, filed on Feb. 6, 2024.

(51) Int. Cl. H01R 13/453; H01R 24/78

(52) U.S. Cl. CPC H01R 13/4534; H01R 24/78

(57) ABSTRACT

A tamper resistant shutter includes a base including a hot opening and a neutral opening; a hot slider including a first sloped portion disposed proximate the hot opening and a first blocking portion structured to block the neutral opening; a neutral slider including a second sloped portion disposed proximate the neutral opening and a second blocking portion structured to block the hot opening; and a spring disposed between the hot slider and the neutral slider and structured to bias the tamper resistant shutter to a closed state, wherein upon pressing on the first sloped portion, the hot slider slides and the first blocking portion moves and no longer blocks the neutral opening, wherein upon pressing on the second sloped portion, the neutral slider slides and the second blocking portion moves and no longer blocks the hot opening.

### CROSS REFERENCE TO RELATED APPLICATIONS

This application claims priority to U.S. Provisional Patent Application Ser. No. 63/550,143, filed on Feb. 6, 2024, and titled “Tamper Resistant Shutter and Receptacle Including the Same,” the disclosure of which is incorporated herein by reference.

### FIELD OF THE INVENTION

The disclosed concept relates generally to an apparatus and system for protection against electrocution, and in particular, to a tamper resistant shutter and receptacle including same.

### BACKGROUND OF THE INVENTION

Tamper resistant shutters are placed in electrical receptacles and prevent an object, such as a pin, wire, or single prong, from being inserted into just one of the hot or neutral openings and touching the corresponding terminals. Tamper resistant shutters open and allow a plug that is simultaneously inserted into both the hot and neutral openings. Tamper resistant shutters are structured to prevent the unintended insertion of an object into the socket. More specifically, tamper resistant shutters are structured to prevent such an unintended object from contacting the live power supply, and thus are a safeguard against electrocution. An exemplary prior art tamper resistant shutter 200 is shown in FIG. 7, and includes six parts, a hot slider 210, two neutral sliders (a first neutral slider 230 and a second neutral slider 240), two springs 250, 260 and a base 270. That is, the existing tamper resistant shutter 200 includes a very small second neutral slider 240 and the two springs 250,260, that are placed in a very small space within a receptacle, thus making the assembly process difficult and unable to be automated.

There is room for improvement in providing protection against electrocution, particularly in tamper resistant shutters for electrical receptacles.

### SUMMARY OF THE INVENTION

These needs, and others, are met by a tamper resistant shutter. The tamper resistant shutter includes: a base having a hot opening and a neutral opening; a hot slider including a first sloped portion disposed proximate the hot opening and a first blocking portion structured to block the neutral opening; a neutral slider including a second sloped portion disposed proximate the neutral opening and a second blocking portion structured to block the hot opening; and a spring disposed between the hot slider and the neutral slider and structured to bias the tamper resistant shutter to a closed state. The hot slider is structured to slide in response to pressing on the first sloped portion, and when the hot slider slides, the first blocking portion of the hot slider moves and no longer blocks the neutral opening. The neutral slider is structured to slide in response to pressing on the second sloped portion, and when the neutral slider slides, the second blocking portion of the neutral slider moves and no longer blocks the hot opening. Pressing on the sloped portions of both the hot and neutral sliders simultaneously causes the tamper resistant shutter to change to an open state. The first blocking portion of the hot slider includes blades structured to block the neutral opening in the closed state and to separate and provide access to the neutral opening in the open state.

Another example embodiment includes a receptacle including a housing and one or more tamper resistant shutters. The housing includes one or more connecting sections a hot outlet and a neutral outlet. A tamper resistant shutter includes: a base having a hot opening and a neutral opening; a hot slider including a first sloped portion disposed proximate the hot opening and a first blocking portion structured to block the neutral opening; a neutral slider including a second sloped portion disposed proximate the neutral opening and a second blocking portion structured to block the hot opening; and a spring disposed between the hot slider and the neutral slider and structured to bias the tamper resistant shutter to a closed state. The hot slider is structured to slide in response to pressing on the first sloped portion, and when the hot slider slides, the first blocking portion of the hot slider moves and no longer blocks the neutral opening. The neutral slider is structured to slide in response to pressing on the second sloped portion, and when the neutral slider slides, the second blocking portion of the neutral slider moves and no longer blocks the hot opening. Pressing on the sloped portions of both the hot and neutral sliders simultaneously causes the tamper resistant shutter to change to an open state. The first blocking portion of the hot slider includes blades structured to block the neutral opening in the closed state and to separate and provide access to the neutral opening in the open state.

### BRIEF DESCRIPTION OF THE DRAWINGS

A full understanding of the invention can be gained from the following description of the preferred embodiments when read in conjunction with the accompanying drawings in which:

FIG. 1 is a top perspective view of a conventional tamper resistant shutter;

FIG. 2 is a top plan view of a receptacle including a plurality of exemplary tamper resistant shutters according to a non-limiting, example embodiment of the disclosed concept;

FIG. 3 is a perspective view of the receptacle of FIG. 2;

FIG. 4 is an exploded view of the receptacle of FIG. 2;

FIG. 5 is a top plan view of an exemplary tamper resistant shutter according to a non-limiting, example embodiment of the disclosed concept;

FIG. 6 is a top perspective view of the exemplary tamper resistant shutter of FIG. 5;

FIG. 7 is a perspective exploded view of the exemplary tamper resistance shutter of FIG. 5;

FIG. 8 is a bottom perspective view of an exemplary hot slider of the exemplary tamper resistant shutter of FIG. 5 according to a non-limiting, example embodiment of the disclosed concept;

FIG. 9 is a bottom perspective view of an exemplary neutral slider of the exemplary tamper resistant shutter of FIG. 5 according to a non-limiting, example embodiment of the disclosed concept;

FIG. 10 is a top perspective view of the exemplary tamper resistant shutter of FIG. 5 in a closed position according to a non-limiting, example embodiment of the disclosed concept;

FIG. 11 is a top perspective view of the exemplary tamper resistant shutter of FIG. 5 in an open position according to a non-limiting, example embodiment of the disclosed concept;

FIG. 12 illustrates tamper protection using the exemplary tamper resistant shutter of FIG. 5 when an object is inserted in a hot opening according to a non-limiting, example embodiment of the disclosed concept;

FIG. 13 illustrates tamper protection using the exemplary tamper resistant shutter of FIG. 5 when an object is inserted in a hot opening according to a non-limiting, example embodiment of the disclosed concept;

FIG. 14 illustrates tamper protection using the exemplary tamper resistant shutter of FIG. 5 when an object is inserted in a hot opening according to a non-limiting, example embodiment of the disclosed concept;

FIG. 15 illustrates tamper protection using the exemplary tamper resistant shutter of FIG. 5 when an object is inserted in a neutral opening of the receptacle according to a non-limiting, example embodiment of the disclosed concept;

FIG. 16 illustrates tamper protection using the exemplary tamper resistant shutter of FIG. 5 when an object is inserted in a neutral opening of the receptacle according to a non-limiting, example embodiment of the disclosed concept;

FIG. 17 illustrates tamper protection using the exemplary tamper resistant shutter of FIG. 5 when an object is inserted in a neutral opening of the receptacle according to a non-limiting, example embodiment of the disclosed concept;

FIG. 18 illustrates tamper protection using the exemplary tamper resistant shutter of FIG. 5 when an object is inserted in a neutral opening of the receptacle according to a non-limiting, example embodiment of the disclosed concept;

FIG. 19 illustrates tamper protection using the exemplary tamper resistant shutter of FIG. 5 when an object is inserted in a neutral opening of the receptacle according to a non-limiting, example embodiment of the disclosed concept;

FIG. 20 illustrates tamper protection using the exemplary tamper resistant shutter of FIG. 5 when an object is inserted in a neutral opening of the receptacle according to a non-limiting, example embodiment of the disclosed concept;

FIG. 21 illustrates the exemplary tamper resistant shutter of FIG. 5 in an open position according to a non-limiting, example embodiment of the disclosed concept;

FIG. 22 illustrates the exemplary tamper resistant shutter of FIG. 5 in an open position according to a non-limiting, example embodiment of the disclosed concept; and

FIG. 23 illustrates the exemplary tamper resistant shutter of FIG. 4 in an open position according to a non-limiting, example embodiment of the disclosed concept.

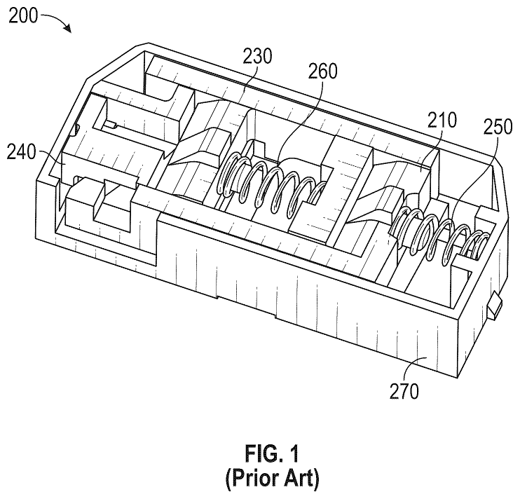

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

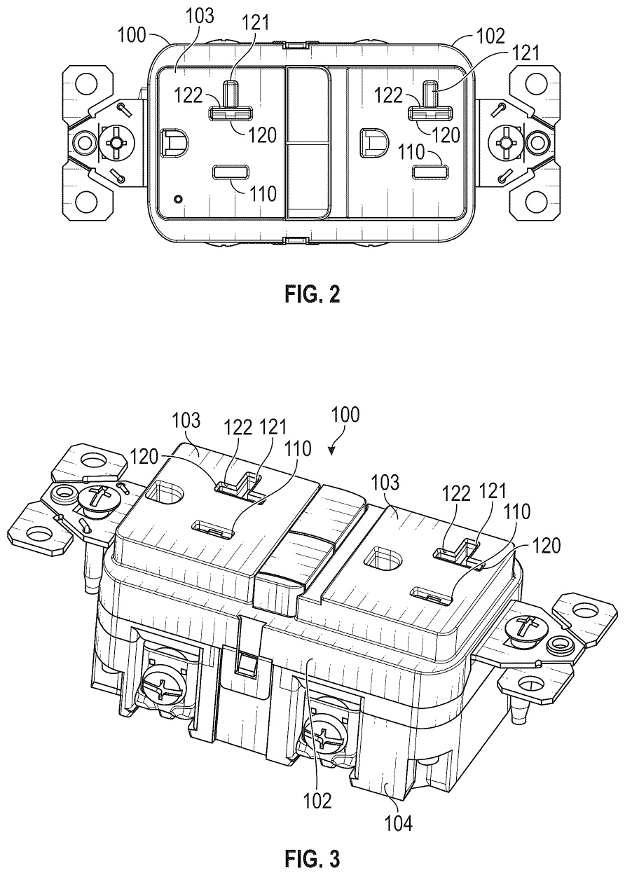

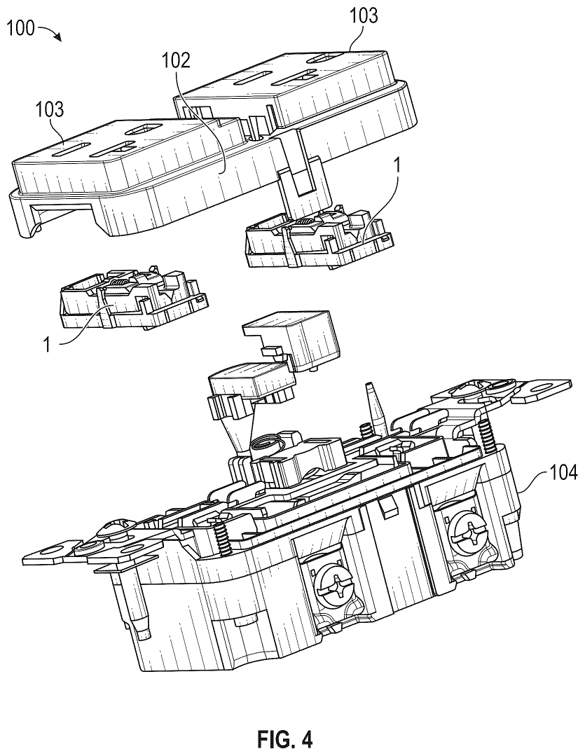

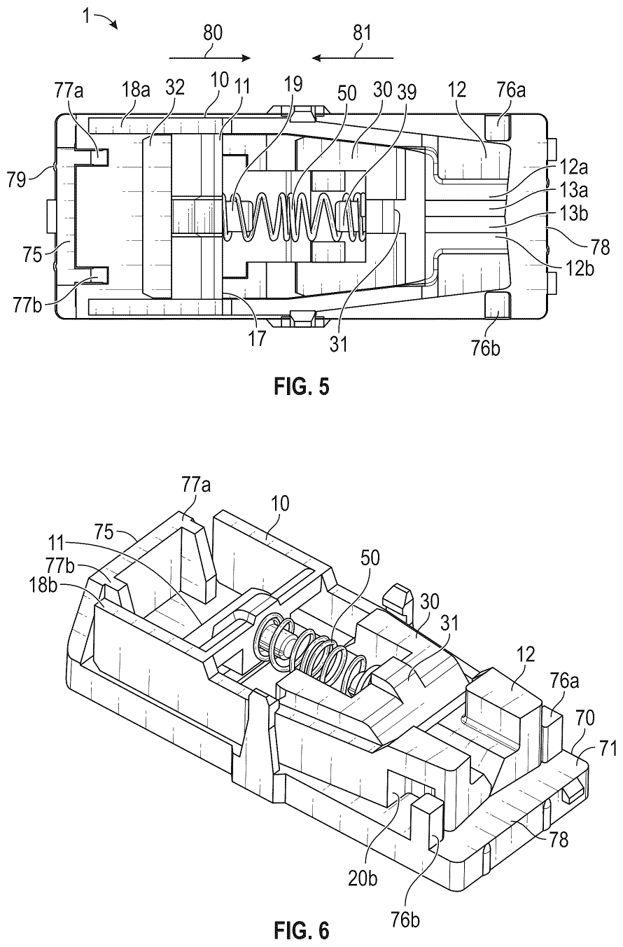

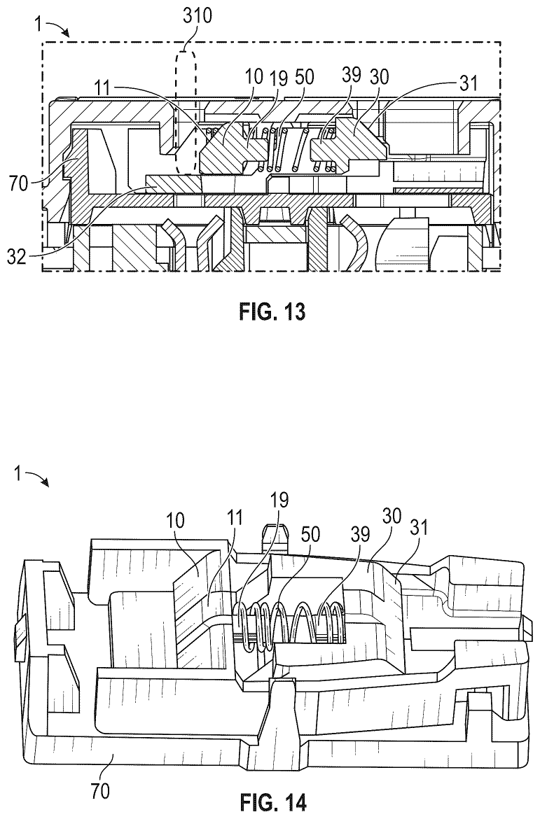

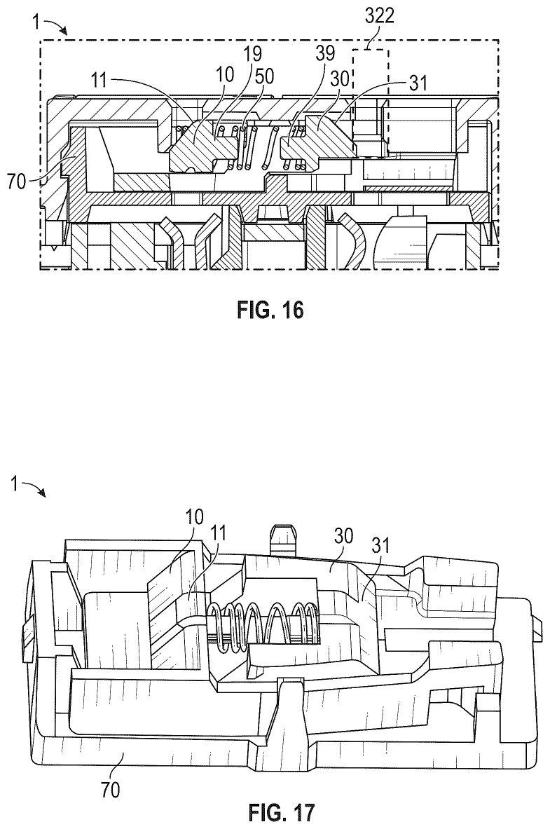

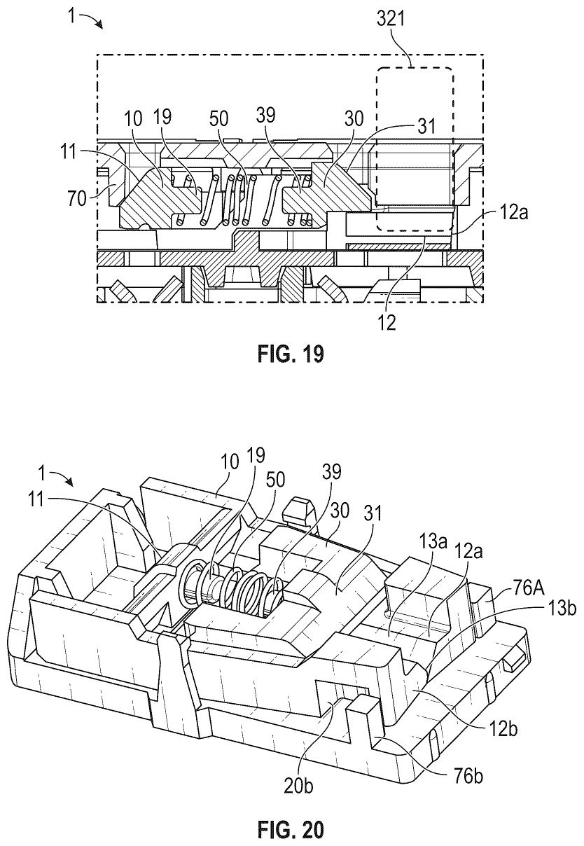

FIGS. 2-23 show a tamper resistant shutter 1 in accordance with an example embodiment of the disclosed concept. The tamper resistant shutter 1 is an improvement over the existing tamper resistant shutter 200. For example, the tamper resistant shutter 1 reduces the number of parts to four, thus providing for an easier assembly process that can be automated. Specifically, as shown in FIGS. 5-23, the tamper resistant shutter 1 includes one hot slider 10, one neutral slider 30, one spring 50, and a base 70, thus providing a tamper resistant shutter functionality without the additional second neutral slider 240 and second spring 260 that were required in the conventional tamper resistant shutter 200. The tamper resistant shutter 1 also requires less insertion force and a smoother insertion compared to the existing tamper resistant shutter 200.

Referring to the figures in further detail, FIGS. 2-4 show a receptacle 100 including an exemplary tamper resistant shutter 1 according to a non-limiting, example embodiment of the disclosed concept. The receptacle 100 may be a dual socket receptacle and includes a top housing 102, a bottom housing 104 and a plurality of tamper resistant shutters 1 as described herein. However, this is for illustrative purposes only and the receptacle may include any number of sockets based on the user needs and circumstances. The top housing 102 includes a plurality of connecting sections 103 each having a hot outlet 110 via which a hot prong of an electrical plug is inserted to connect to a hot terminal and a neutral outlet 120 via which a neutral prong of an electrical plug is inserted to connect to a neutral terminal. The neutral outlet 120 may include a first neutral outlet portion 121 via which a 20 Amp (A) neutral prong of an electrical plug is inserted and a second neutral outlet portion 122 via which a 15 Amp neutral prong of an electrical plug is inserted. The tamper resistant shutters 1 are structured to be disposed within the top housing 102 and structured to block the outlets 110,120 in a closed state (when prongs of an electrical plug are not inserted into the outlets 110,120 of the receptacle 100).

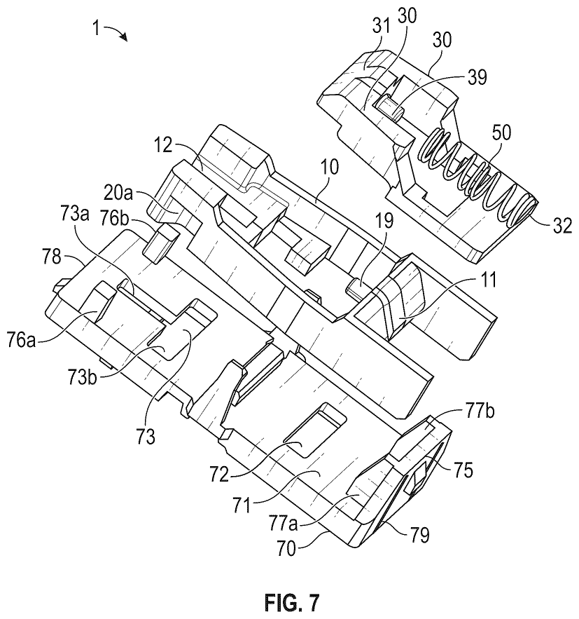

Referring to FIGS. 5-7, the tamper resistant shutter 1 includes a hot slider 10, a neutral slider 30, a spring 50, and a base 70 having a hot opening 72 and a neutral opening 73 (FIG. 7). The hot slider 10 includes a first sloped portion 11 disposed by the hot opening 72 and a first blocking portion 12 disposed by the neutral opening 73 and structured to block the neutral opening 73 when the tamper resistant shutter 1 is in a closed state (when prongs of an electrical plug are not inserted into the hot opening 72 and/or the neutral opening 73). The spring 50 is disposed between the hot slider 10 and the neutral slider 30 and is structured to bias the tamper resistant shutter 1 to a closed state. The neutral slider 30 includes a second sloped portion 31 disposed by the neutral opening 73 and a second blocking portion 32 disposed by the hot opening 72 and structured to block the hot opening 72 when the tamper resistant shutter 1 is in the closed state. In some examples, the neutral opening 73 of the base 70 may include a first neutral opening portion 73a extending horizontally and via which a 20 Amp neutral prong of an electric plug is inserted, and a second neutral opening portion 73b extending vertically and via which a 15 Amp neutral prong of an electric plug is inserted. The base 70 further includes protrusions 76a and 76b extending outwardly and perpendicular to the upper surface 71 and structured to keep the first blocking portion 12 from opening when the tamper resistant shutter 1 is in the closed state. Optionally, the base 70 may also include a side wall 75 and projections 77a and 77b each extending from the side wall 75 horizontally inwardly so as to form recesses to receive legs 18a and 18b each extending from side edges of the first blocking portion 12 of the hot slider 10 as a securing mechanism when the tamper resistant shutter 1 is in the closed position. Optionally, the hot slider 10 may have a flat inner surface 17 including a first spring holder 19 structured to hold one end of the spring 50. Optionally, the second sloped portion 31 of the neutral slider 30 may have a second spring holder 39 structured to hold the other end of the spring 50. The spring 50 may be any type of clastic spring, e.g., without limitation, a steel spring, a plastic spring, etc.

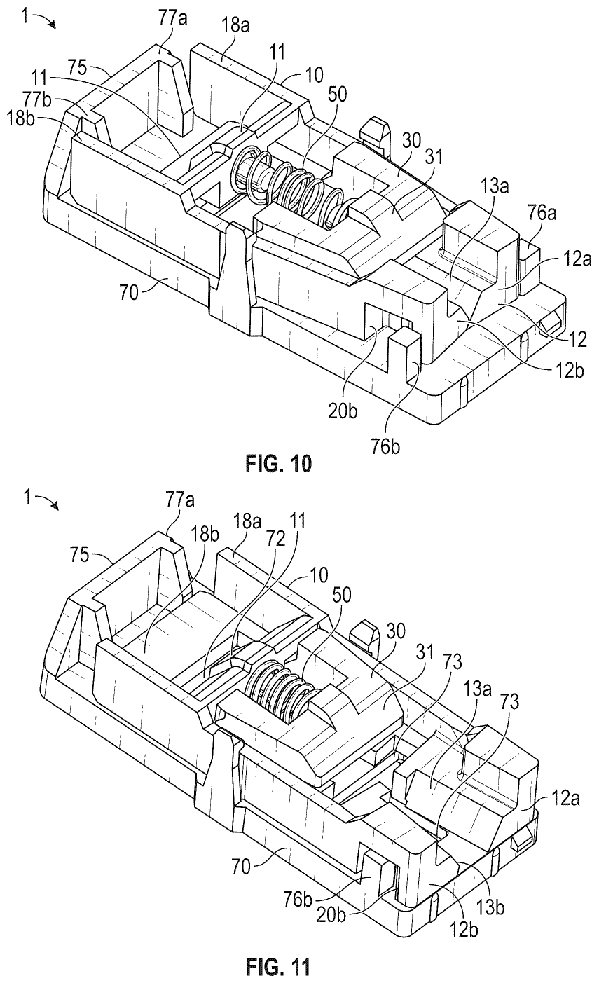

The first blocking portion 12 of the hot slider 10 includes blades 12a and 12b that separate to provide access to the neutral opening 73, as shown in FIG. 11. The blades 12a and 12b are blocked from opening by the protrusions 76a and 76b in the base 70 (FIG. 7) when the tamper resistant shutter 1 is in the closed state, as shown in FIG. 10. However, when the hot slider 10 moves to the open state (when prongs are inserted in both the hot opening 72 and the neutral opening 73), notches 20a and 20b in the first blocking portion 12 are able to receive the protrusions 76a and 76b in the base 70, thus allowing the blades 12a and 12b to separate as shown in FIG. 11. The blades 12a and 12b have sloped edges 13a and 13b which allow the prong of the electrical plug to separate the blades 12a and 12b smoothly when the tamper resistant shutter 1 is in the open state. The blades 12a and 12b are also structured to be biased toward the closed position and will automatically close when a prong is removed.

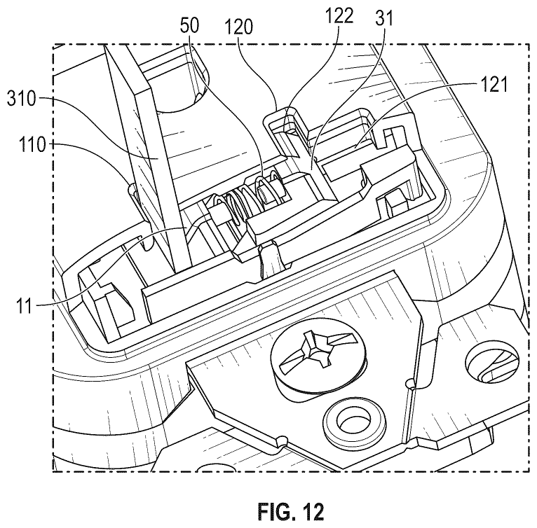

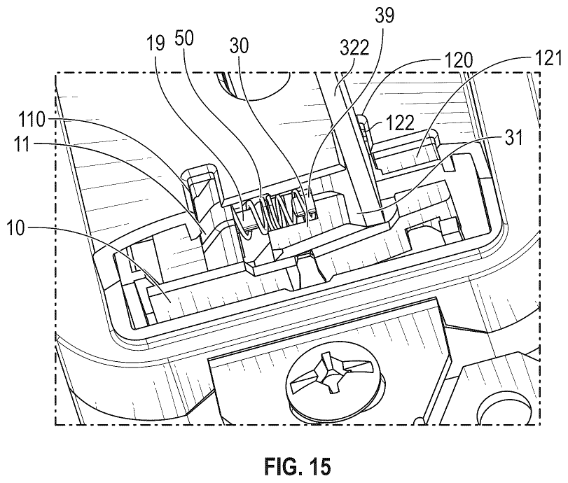

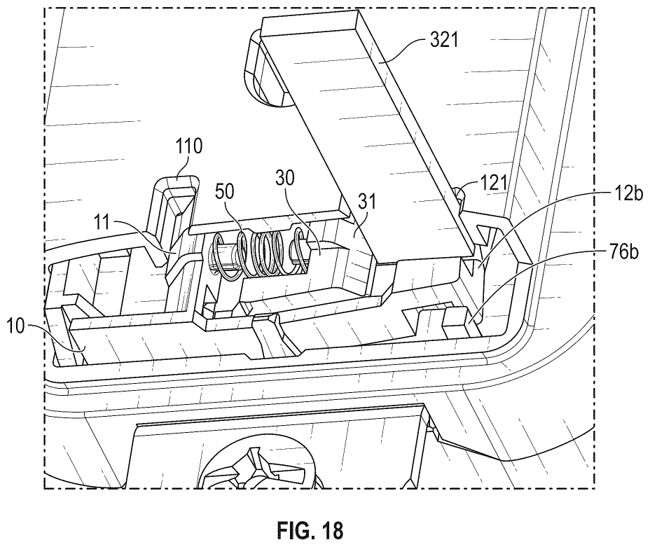

As shown in FIGS. 12, 13 and 14, when a prong 310 is inserted into the hot outlet 110, it presses against the first sloped portion 11 of the hot slider 10 causing the hot slider 10 to move inwardly in a direction 80 towards a first end 78 (FIGS. 5-7) of the base 70. The prong 310 may be, e.g., without limitation, plastic, metallic or conductive parts. However, the neutral slider 30 remains in position and its blocking portion (the second blocking portion) 32 continues to block the hot opening 72 (FIG. 7), preventing the prong 310 from reaching the hot terminal. As shown in FIGS. 15, 16, and 17, when a prong 322 is inserted into the second neutral outlet portion 122, it presses against the second sloped portion 31 of the neutral slider 30 causing the neutral slider 30 to move inwardly in a direction 81 toward the second end 79 of the base 70, but the hot slider 10 does not move and its blocking portion (the first blocking portion) 12 continues to block the neutral opening 73, preventing the prong from reaching the 15 Amp neutral terminal. As shown in FIGS. 18, 19 and 20, when a prong 321 is inserted into a first neutral outlet portion 121, it presses against the blades 12a and 12b of the first blocking portion 12 of the hot slider 10, but the blocking portions 76a and 76b prevent the blades 12a and 12b from separating, thus preventing the prong 321 from being inserted into the first neutral opening portion 73a. Neither the hot slider 10 nor the neutral slider 30 move in this scenario. As such, the tamper resistant shutter 1 has a dual interlocking that ensures blocking of the openings 72,73 in two opposing directions (blocking of the hot opening 72 by the second blocking portion 32 and blocking of the neutral opening 73 by the first blocking portion 12). The dual interlocking is released only upon inserting prongs into both the hot outlet 110 and the neutral outlet 120 at the same time. That is, when prongs are inserted into both the hot outlet 110 and the neutral outlet 120 simultaneously, both the hot slider 10 and the neutral slider 30 move inwardly (against the bias of the spring 50) and the blocking portions 32,12 no longer cover their corresponding openings 73,72 as shown in FIG. 11, thus allowing a plug to be inserted into the receptacle 100.

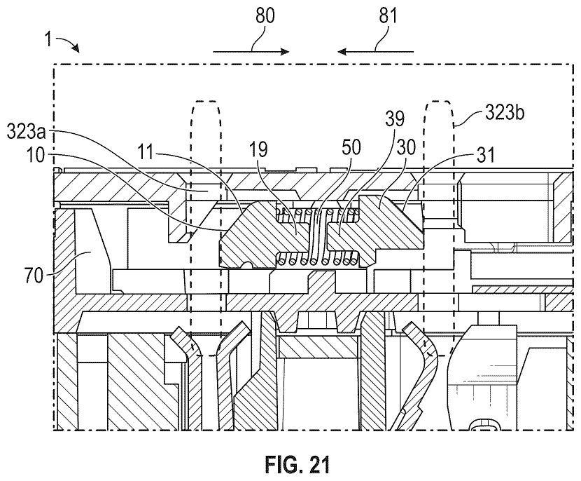

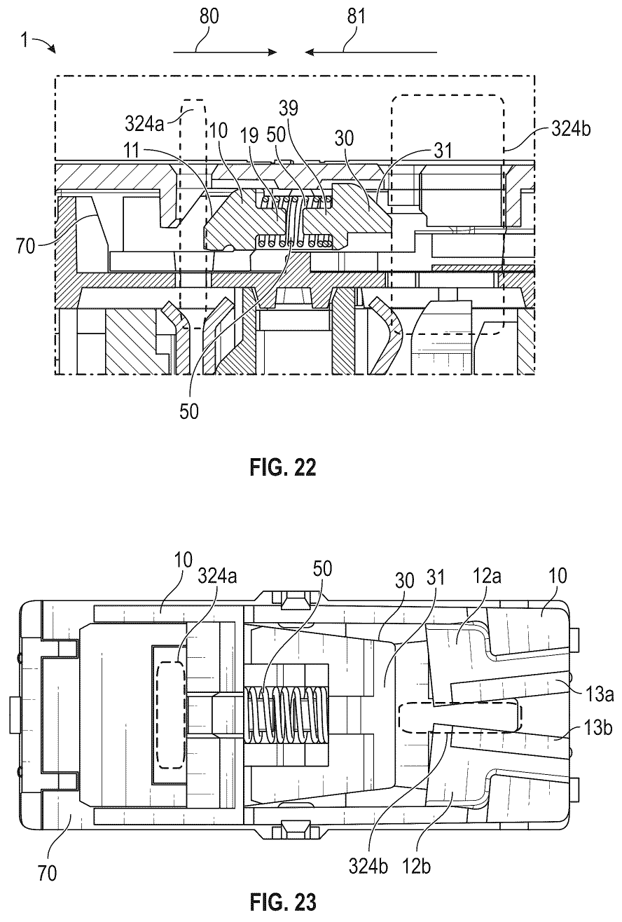

For example, as shown in FIG. 21, when prongs 323a and 323b of a 15 Amp plug are inserted into the outlets 110,122 of the receptacle 100, both the hot slider 10 and the neutral slider 30 move inwardly in opposing directions 80 and 81, respectively, releasing the dual interlock and uncovering the respective openings 72 and 73b. In another example, as shown in FIGS. 22 and 23. when prongs 324a and 324b of a 20 Amp plug is inserted into the outlets 110,121 of the receptacle 100, both the hot slider 10 and the neutral slider 30 move inwardly in opposing directions 80 and 81, respectively, as a result of the prongs 324a and 324b engaging the first sloped portion 11 and the second sloped portion 31, respectively. Upon moving of the neutral slider 30 in the direction 81, the interlocking of the hot opening 72 by the second blocking portion 32 is released and the hot opening 72 is uncovered. Upon moving of the hot slider 10 in the direction 80, the first blocking portion 12 moves past the protrusions 76a and 76b, releasing the interlocking of the blades 12a and 12b of the first blocking portion 12. The protrusions 76a and 76b are then received within respective notches 20a and 20b, allowing the blades 12a and 12b to separate and uncovering the first neutral opening portion 73a.

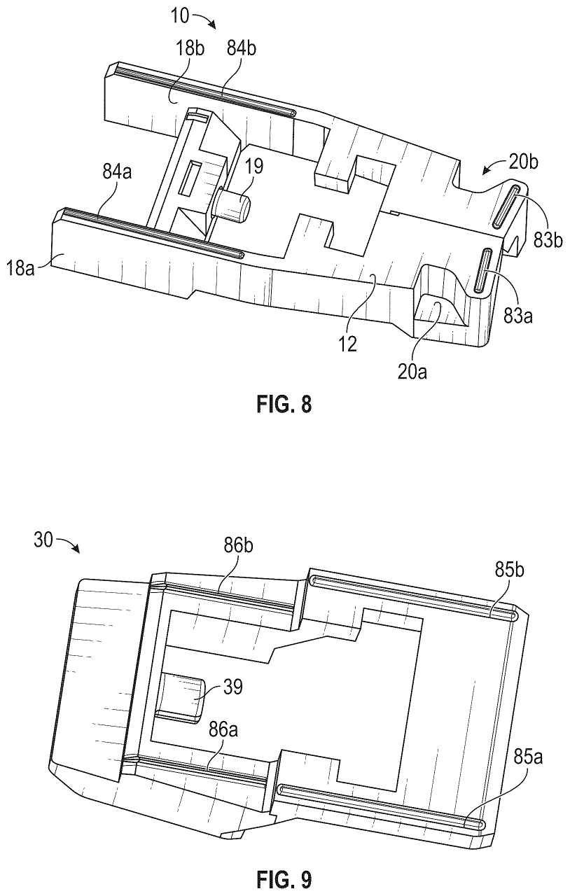

The tamper resistant shutter 1 is designed to accept a plug having different length prongs. In some example embodiments of the disclosed concept, the sloped portions 11,31 of the sliders 10,30 have a ten degree slope to provide maximum movement of the sliders 10,30 when prongs are inserted. In some example embodiments, the hot slider 10 and/or the neutral slider 30 may have slightly raised contact lines 83a, 83b, 84a, 84b, 85a, 85b, 86a, 86b on respective bottom surfaces as shown in FIGS. 8 and 9. For example, as shown in FIG. 8, the legs 18a, 18b of the hot slider 10 each may have raised contact lines 84a,b at the bottom, and/or the bottom surface of the first blocking portion 12 may include raised contacts lines 83a,b at one end. In another example, as shown in FIG. 9, the neutral slider 30 may have contact lines 85a, 85b and 86a, 86b. The slightly raised contact lines 83a, 83b, 84a, 84b, 85a, 85b, 86a, 86b reduce friction between the sliders 11,31 and the base 70, and thus allow smoother insertion.

As such, no single prong alone can be inserted into any of the hot opening 72 and the neutral opening 73 due to the dual-interlocking provided by the first blocking portion 12 and the second blocking portion 32. That is, in order to place the tamper resistant shutter 1 into an open state, the dual-interlocking must be released, not just one interlocking by either blocking portion 12,32 by inserting prongs into both the hot opening 72 and the neutral opening 73 simultaneously. The hot opening 72 of the base 70 and the hot opening 110 of the receptacle 100 are aligned such that a prong can be connected to the hot terminal via both hot openings 72,110, and the neutral opening 73 of the base 70 and the neutral opening 120 are aligned such that a prong can be connected to the neutral terminal via both the neutral openings 73, 120 in the open state.

As described above, the tamper resistant shutter 1 in accordance with an example embodiment of the disclosed concept provides minimal parts and still provides all tamper resistant functionality. The tamper resistant shutter 1 of the disclosed concept is an improvement as the reduction in parts reduces the time and complexity of the assembly process, allows for automated assembly, and reduces costs.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A tamper resistant shutter for an electrical receptable, comprising:
a base having a first longitudinal axis and having a hot opening and a neutral opening, wherein the hot opening has a second longitudinal axis that is perpendicular to the first longitudinal axis, and wherein the neutral opening has a first portion having a third longitudinal axis that is perpendicular to the first longitudinal axis and a fourth longitudinal axis that is parallel to the first longitudinal axis;
a hot slider slidable relative to the base and including a first sloped portion disposed proximate the hot opening and a first blocking portion structured to block the neutral opening, and wherein the first blocking portion includes first and second blades;
a neutral slider slidable relative to the base including a second sloped portion disposed proximate the neutral opening and a second blocking portion structured to block the hot opening; and
a spring disposed between the hot slider and the neutral slider and structured to bias the tamper resistant shutter to a closed state where the first blocking portion blocks the neutral opening and the second blocking portion blocks the hot opening, wherein in the closed state the first and second blades are positioned immediately adjacent one another;
wherein the hot slider is structured to slide against the bias of the spring in response to a first prong having a length and a width pressing on the first sloped portion when the first prong is positioned such that the width of the first prong extends parallel to the second longitudinal axis of the hot opening, and wherein when the hot slider slides, the first blocking portion of the hot slider moves and no longer blocks the neutral opening;
wherein the neutral slider is structured to slide against the bias of the spring in response to a second prong having a length and a width pressing on the second sloped portion when the second prong is positioned such that the width of the second prong extends parallel to the third longitudinal axis of the neutral opening or in response to a third prong having a length and a width pressing on the second sloped portion when the third prong is positioned such that the width of the third prong extends parallel to the fourth longitudinal axis of the neutral opening, wherein when the neutral slider slides, the second blocking portion of the neutral slider moves and no longer blocks the hot opening, and wherein the first and second blades will separate from one another in response to the third prong pressing against the first and second blades; and
wherein the tamper resistant shutter is structured to change to an open state where the first blocking portion does not block the neutral opening and the second blocking portion does not block the hot opening only in response to pressing on the sloped portions of both the hot and neutral sliders simultaneously.

2. The tamper resistant shutter of claim 1, wherein in the closed state the first and second blades contact one another.

3. The tamper resistant shutter of claim 1, wherein the first and second blades each include notches, wherein the base includes protrusions, wherein the protrusions of the base prevent the blades from separating when the tamper resistant shutter is in the closed state, and wherein the notches are structured to receive the protrusions and allow the blades to separate responsive to the sliding of the hot slider to move the tamper resistant shutter to the open state.

4. The tamper resistant shutter of claim 3, wherein the first and second blades each include sloped edges, and wherein pressure against the sloped edges of the blades causes the blades to separate.

5. The tamper resistant shutter of claim 4, wherein the sloped portions have a ten degree slope.

6. The tamper resistant shutter of claim 1, wherein the hot slider has raised contact lines on a bottom surface thereof and wherein the raised contact lines reduce friction associated with sliding of the hot slider.

7. The tamper resistant shutter of claim 1, wherein the neutral slider has raised contact lines on the bottom surface thereof and wherein the raised contact lines reduce friction associated with sliding of the neutral slider.

8. The tamper resistant shutter of claim 1, wherein the first sloped portion is located at a first end of the hot slider and the first blocking portion is located at a second end of the hot slider opposite the first end, and wherein the second sloped portion is located at a first end of the neutral slider and the second blocking portion is located at a second end of the neutral slider opposite the first end.

9. The tamper resistant shutter of claim 8, wherein the first end of the hot slider includes a first protruding member positioned opposite the first sloped portion, wherein the first end of the neutral slider includes a second protruding member positioned opposite the second sloped portion, and wherein a first end of the spring is directly coupled to the first protruding member and the second end of the spring is directly coupled to the second protruding member.

10. An electrical receptacle comprising:
a housing including one or more connecting sections a hot outlet and a neutral outlet; and
one or more tamper resistant shutters structured to be disposed within the housing, each tamper resistant shutter including:
a base having a first longitudinal axis and having a hot opening and a neutral opening, wherein the hot opening has a second longitudinal axis that is perpendicular to the first longitudinal axis, and wherein the neutral opening has a first portion having a third longitudinal axis that is perpendicular to the first longitudinal axis and a fourth longitudinal axis that is parallel to the first longitudinal axis;
a hot slider slidable relative to the base and including a first sloped portion disposed proximate the hot opening and a first blocking portion structured to block the neutral opening, and wherein the first blocking portion includes first and second blades;
a neutral slider slidable relative to the base including a second sloped portion disposed proximate the neutral opening and a second blocking portion structured to block the hot opening; and
a spring disposed between the hot slider and the neutral slider and structured to bias the tamper resistant shutter to a closed state where the first blocking portion blocks the neutral opening and the second blocking portion blocks the hot opening, wherein in the closed state the first and second blades are positioned immediately adjacent one another;
wherein the hot slider is structured to slide against the bias of the spring in response to a first prong having a length and a width pressing on the first sloped portion when the first prong is positioned such that the width of the first prong extends parallel to the second longitudinal axis of the hot opening, and wherein when the hot slider slides, the first blocking portion of the hot slider moves and no longer blocks the neutral opening;
wherein the neutral slider is structured to slide against the bias of the spring in response to a second prong having a length and a width pressing on the second sloped portion when the second prong is positioned such that the width of the second prong extends parallel to the third longitudinal axis of the neutral opening or in response to a third prong having a length and a width pressing on the second sloped portion when the third prong is positioned such that the width of the third prong extends parallel to the fourth longitudinal axis of the neutral opening, wherein when the neutral slider slides, the second blocking portion of the neutral slider moves and no longer blocks the hot opening, and wherein the first and second blades will separate from one another in response to the third prong pressing against the first and second blades; and
wherein the tamper resistant shutter is structured to change to an open state where the first blocking portion does not block the neutral opening and the second blocking portion does not block the hot opening only in response to pressing on the sloped portions of both the hot and neutral sliders simultaneously.

11. The electrical receptacle of claim 10, wherein in the closed state the first and second blades contact one another.

12. The electrical receptacle of claim 10, wherein the first and second blades each include notches, wherein the base includes protrusions, wherein the protrusions of the base prevent the blades from separating when the tamper resistant shutter is in the closed state, and wherein the notches are structured to receive the protrusions and allow the blades to separate responsive to the sliding of the hot slider to move the tamper resistant shutter to the open state.

13. The electrical receptacle of claim 12, wherein the first and second blades each include sloped edges, and wherein pressure against the sloped edges of the blades causes the blades to separate.

14. The electrical receptacle of claim 13, wherein the sloped portions have a ten degree slope.

15. The electrical receptacle of claim 10, wherein the hot slider has raised contact lines on a bottom surface thereof and wherein the raised contact lines reduce friction associated with sliding of the hot slider.

16. The electrical receptacle of claim 10, wherein the neutral slider has raised contact lines on the bottom surface thereof and wherein the raised contact lines reduce friction associated with sliding of the neutral slider.

17. The electrical receptacle of claim 10, wherein the first sloped portion is located at a first end of the hot slider and the first blocking portion is located at a second end of the hot slider opposite the first end, and wherein the second sloped portion is located at a first end of the neutral slider and the second blocking portion is located at a second end of the neutral slider opposite the first end.

18. The electrical receptacle of claim 17, wherein the first end of the hot slider includes a first protruding member positioned opposite the first sloped portion, wherein the first end of the neutral slider includes a second protruding member positioned opposite the second sloped portion, and wherein a first end of the spring is directly coupled to the first protruding member and the second end of the spring is directly coupled to the second protruding member.
